(19) United States
(12) Patent Application Publication
(10) Pub. No.: US 2023/0358076 A1
(43) Pub. Date: Nov. 9, 2023

(54) Key case

(71) Applicant: Shenzhen Hanmai Technology Co., Ltd, Shenzhen (CN)

(72) Inventor: Wenyuan Zhang, Zhangshu (CN)

(21) Appl. No.: 18/309,794

(22) Filed: Apr. 29, 2023

(30) Foreign Application Priority Data
May 5, 2022 (CN) 202221057858.8
Jun. 24, 2022 (CN) 202221605044.3

(51) Int. Cl. E05B 47/00; E05B 19/00

(52) U.S. Cl. CPC E05B 47/0001; E05B 19/0005; E05B 2047/002

(57) ABSTRACT

The present disclosure provides a key case, and relates to the technical field of key cases. In the key case, the unlocking drive unit can be prevented from supplying power always and maintaining the unlocking state, the power can be effectively saved, so that the key case is more energy-saving and environment-friendly.

### TECHNICAL FIELD

The present disclosure relates to the technical field of key cases, in particular to a key case.

### BACKGROUND

A lock is one of commonly used articles in people’s life, the general lock only implements the function of locking an object, and however users need to take along keys or room cards, bringing inconvenience and a risk of forgetting or losing the keys and the room cards. In order to solve this problem, some people will keep spare keys outside their home, the spare keys are hidden in flowerpots, or ground mat or other insignificant places, but doing this exists serious potential risk, some thieves are good at finding this loophole, rummage the ground of a shop or shoes on a shoe rack from door to door to check if there are keys, and then they can seize the chance to enter the room for stealing. Therefore, a key case for storing the key or the room card is emerged, and the key case is installed at the door; and the users lock the key case in a manner of not using the key when leaving home.

However, the key case in the prior art exists some defects. For example, an unlocking mechanism is operated by hands every time due to adopting a mechanical password, the operation is tedious, the using convenience of the key case is affected, and at the same time, the key case is not suitable for these users with inflexible fingers. Moreover, the unlocking structure is always in a power supply state after being unlocked, which is not conductive to saving power, so the key case needs to be improved.

### SUMMARY

In order to overcome the deficiencies of the above situation, the present disclosure aims at providing a technical solution for solving the above problem.

A key case, including a case body for storing keys and a case cover installed on the case body, the case cover is a hollow shell structure, an unlocking drive unit, a main control unit, an unlocking execution unit and a power supply unit are arranged in the case cover, and the unlocking drive unit, the main control unit and the unlocking execution unit are electrically connected to the power supply unit in respective;

The unlocking execution unit includes a motor, a gear, a locking block and a travel switch, the motor is fixed in the case cover, and the gear is in power fit with the motor; the locking block is slidingly connected in the case cover, a rack is arranged on the locking block, and the gear meshes with the locking block through the rack; the travel switch is fixed in the case cover and driven through the locking block; and a snap ring is arranged on the case body, and the snap ring is in clamping fit with the locking block.

As a further solution of the present disclosure, a hinged structure is arranged at a joint of the case body and the case cover, and the case body is rotationally connected to the case cover through the hinged structure.

As a further solution of the present disclosure, a first rotating shaft is arranged in the case cover, the gear rotates around the first rotating shaft, a first ratchet wheel that is in power connection with an output end of the motor is arranged on the motor, a second ratchet wheel that fits with the first ratchet wheel is formed on one end of the gear, and the first ratchet wheel meshes with the second ratchet wheel uniaxially.

As a further solution of the present disclosure, a first fixed block and a second fixed block are arranged in the case cover, one end of the first rotating shaft is fixed on the first fixed block, and the second fixed block is arranged at one end of an activity journey of the locking block.

As a further solution of the present disclosure, a first spring is arranged on the first rotating shaft and limited between the gear and the first fixed block, a second rotating shaft is arranged at the lower end of the locking block, a second spring is arranged on the second rotating shaft, and the second spring is limited between the locking block and the second fixed block.

As a further solution of the present disclosure, a lock bolt is formed at the upper end of the locking block, the front end of the lock bolt is a plane for clamping the snap ring, and the rear end of the lock bolt is an inclined plane that is in guided fit with the snap ring.

As a further solution of the present disclosure, teeth on the gear and teeth on the rack are all skewed tooth structures.

As a further solution of the present disclosure, the unlocking drive unit includes electronic password unlocking and fingerprint unlocking.

As a further solution of the present disclosure, the power supply unit includes a battery pack, an emergency pouch battery, an emergency charging interface and a solar liquid crystal board that are arranged in the case body, and the emergency charging interface and one end of the solar liquid crystal board protrude from the case cover.

As a further solution of the present disclosure, the opening of the case body is arranged at the front end of the case body, a support frame is arranged around the periphery of the case body, the periphery of the case cover resists to the support frame, barrier plates, covered at the two sides of the case cover, are respectively arranged on both sides of the case body, protrusion portions that fit with the front end face of the case cover are convexly arranged at the left and right positions, located on the support frame, of the case body in respective, and depression portions that fit with the protrusion portions are concavely arranged on both sides of the case cover in respective.

As a further solution of the present disclosure, the case cover includes a front cover, a cover plate and a rear cover, and the unlocking drive unit, the main control unit, the unlocking execution unit and the power supply unit are all arranged on the cover plate.

As a further solution of the present disclosure, a fixed frame is arranged at the periphery of the rear cover, the cover plate is arranged on the rear cover through the fixed frame, a step portion is arranged on the periphery of the front cover, the front cover is covered to the periphery of the rear cover after resisting to the fixed frame through the step portion, a male buckle is arranged on the cover plate, a guide hole is formed in the rear cover, and a female buckle fitting with the male buckle and a guide column fitting with the guide hole are arranged on the front cover.

As a further solution of the present disclosure, the two ends of the fixed frame are provided with support seats, and the depression portions are arranged on the support seats.

As a further solution of the present disclosure, a reinforced bar is also arranged on the cover plate, the two ends of the reinforced bar resist to the two ends of the cover plate in respective, and a resisting column fitting with the reinforced bar is arranged on the front cover.

As a further solution of the present disclosure, a window is arranged on the surface of the front cover, a drawer corresponding to the window is arranged in the front cover, the drawer is slidingly connected to a sliding plate, which is used to open or close the window, and the control end of the unlocking drive unit is arranged on the window.

As a further solution of the present disclosure, a third fixed block is fixedly installed at the upper end of the support frame, the snap ring is fixedly installed on the third fixed block, through holes, corresponding to the snap ring, are formed on the rear cover and the cover plate, where the through holes correspond to the position of the locking block, and one end the snap ring is in clamping fit with the locking block.

As a further solution of the present disclosure, the hinged structure includes a fixed hinge that is arranged at the lower end of the support frame and a movable hinge that is arranged at the lower end of the rear cover, and the fixed hinge is in hinged fit with the movable hinge.

As a further solution of the present disclosure, the case body is detachably connected to a hook, a multi-layer clamping position is arranged at the lower end of the hook, and a touch through hole that fits with the multi-layer clamping position is arranged in the case body.

As a further solution of the present disclosure, a plurality of bar positions, uniformly distributed, are arranged on the two ends of the case body.

As a further solution of the present disclosure, an attachment for hanging the keys is arranged in the case body.

Compared with the prior art, the present disclosure has the following beneficial effects:

1) The gear is driven to rotate by setting the motor, so that the locking block meshing with the gear is driven to slide. When the locking block triggers the travel switch to start timing during the sliding process, the locking block slides back and forth slightly under the action of the acting force applied to the locking block by the motor and the counter-acting force applied to the locking block by the second spring, the acting force and the counter-acting force generate conflict, and at this time, a structure for combining the first ratchet wheel, the second ratchet wheel and the first spring will generate a clutch action to eliminate the counter-acting force. After timing is end, the locking block is only subjected to the counter-acting force of the second spring to slide and return to the original position. The motor in the key case can complete the whole unlocking process through single rotation, to avoid that the unlocking drive unit supplies power always and maintains the unlocking state, and to save power effectively, so that the key case is more energy-saving and environment-friendly.

2) The unlocking drive unit includes the electronic password unlocking and fingerprint unlocking at the same time, the electronic password unlocking is not easy to be cracked and opened due to better confidentiality and more coding quantities, and the fingerprint unlocking is safe, reliable, convenient, quick, intelligent and fashion. The electronic password unlocking and fingerprint unlocking are arranged at the same time, so the key case has good stability and is convenient for different crowds.

3) The key case is also provided with the solar liquid crystal board, the solar energy is converted into electric energy, so that the key case is more energy-saving. The replacing frequency of the battery is reduced, so the key case is more environment-friendly.

4) The key case adopts the double-sealing setting. First, the barrier plates, covering the two sides of the case cover, are formed on the two sides of the case body in respective, this manner is used as the edge-sealing setting of the outer layers of the left and right ends of the key case, and the barrier plates may be in a thickened design, so as to improve the strength. Second, the support frame is arranged at the periphery of the opening of the case body, the periphery of the case cover resists to the support frame, the protrusion portions that fit with the front end face of the case cover are convexly arranged at the left and right positions, located on the support frame, of the case body in respective, the depression portions that fit with the protrusion portions are concavely arranged on the two sides of the case cover, and this manner is used as the edge-sealing setting of the inner layers of the left and right ends of the key case, so as to achieve the double-sealing effect. With high strength and high tightness, the key case enables the joint between the case cover and the case body to be sealed rigorously through the setting of double-sealing, the key case can prevent lawbreakers from damaging the case body and case cover through the gap between the case body and the case cover to take out the key in the case body, so that the key case is worth promoting with better energy-saving performance and high safety coefficient.

The additional aspects and advantages of the present disclosure will be given in the description below, some will be obvious from the description below, or be understood from the practice of the present disclosure.

### BRIEF DESCRIPTION OF THE DRAWINGS

To better clarify the embodiment of the present disclosure or the technical solution in the prior art, the drawings required to illustrate the embodiments or the prior art will be simply described below. It is apparent that the drawings described below merely illustrate some embodiments of the present disclosure. Those ordinarily skilled in the art can obtain other drawings according to these drawings without contributing creative labor on the basis of those drawings.

FIG. 1 is a structural schematic diagram of the present disclosure;

FIG. 2 is a structural schematic diagram that an unlocking execution unit is in a case cover of the present disclosure;

FIG. 3 is a schematic diagram of an enlarged structure of a part A in FIG. 2;

FIG. 4 is a schematic diagram of an exploded structure of the present disclosure;

FIG. 5 is a structural schematic diagram that a case cover is opened in a case body of the present disclosure;

FIG. 6 is a schematic diagram of a section structure of the present disclosure;

FIG. 7 is a structural schematic diagram of a hook in the present disclosure;

FIG. 8 is a structural schematic diagram of a case body in the present disclosure; and

FIG. 9 is a structural schematic diagram of a front cover in the present disclosure.

Reference signs and names in the drawings are as follows:

Case body-10, support frame-11, barrier plate-12, protrusion portion-13, third fixed block-14, hook-15, clamping position-16, touch through hole-17, bar position-18, attachment-19, case cover-20, depression portion-21, front cover-22, cover plate-23, rear cover-24, fixed frame-25, step portion-26, male buckle-27, guide hole-28, female buckle-29, guide column-201, support seat-202, reinforced bar-203, resisting column-204, window-205, drawer-206, sliding plate-207, through hole-208, unlocking drive unit-30, electronic password unlocking-31, fingerprint unlocking-32, main control unit-40, unlocking execution unit-50, motor-51, gear-52, locking block-53, travel switch-54, rack-55, snap ring-56, first rotating shaft-57, first ratchet wheel-58, second ratchet wheel-59, first fixed block-501, second fixed block-502, first spring-503, second rotating shaft-504, second spring-505, lock bolt-506, power supply unit-60, battery pack-61, emergency pouch battery-62, emergency charging interface-63, solar liquid crystal board-64, hinged structure-70, fixed hinge-71, movable hinge-72.

### DETAILED DESCRIPTION OF THE EMBODIMENTS

The technical solutions in the embodiments of the present disclosure are clearly and completely elaborated below in combination with the drawings. It is apparent that the described embodiments are only a part of the embodiments of the present disclosure but not all. Based on the embodiments of the present disclosure, all the other embodiments obtained by those of ordinary skill in the art on the premise of not contributing creative effort should belong to the protection scope of the present disclosure.

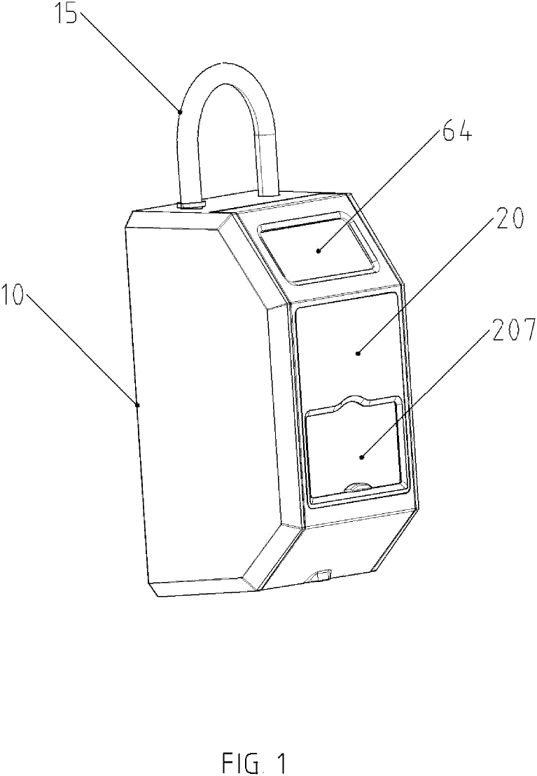

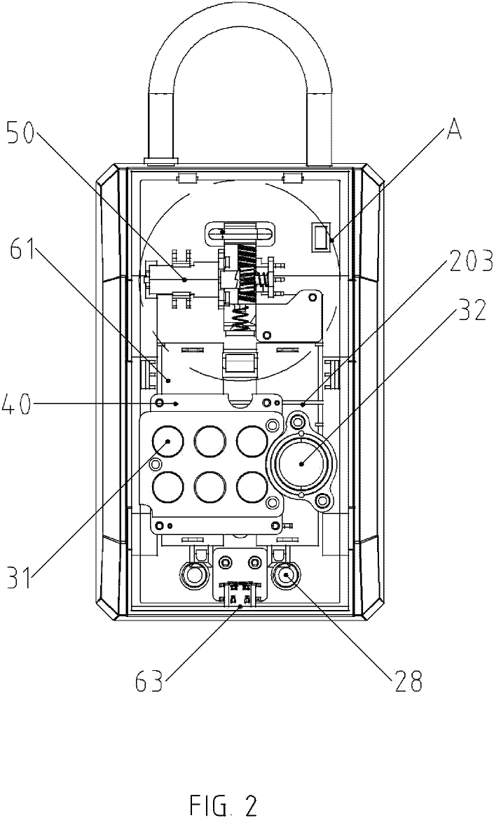

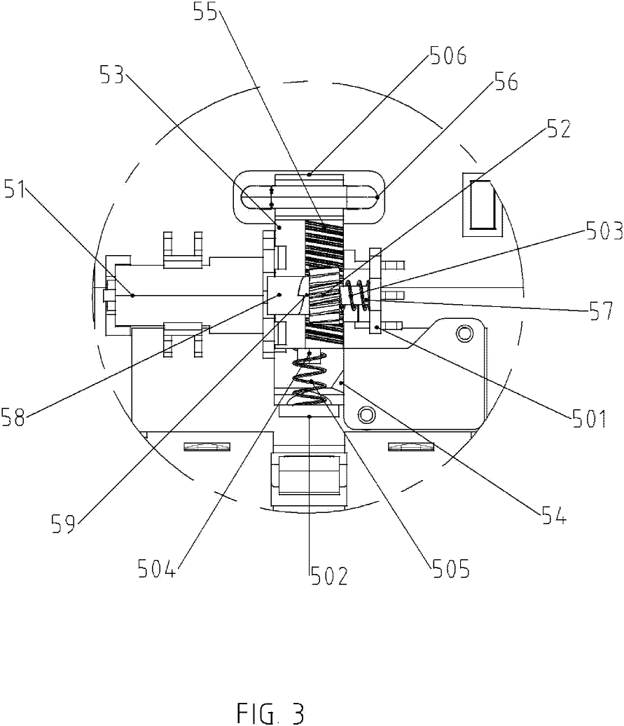

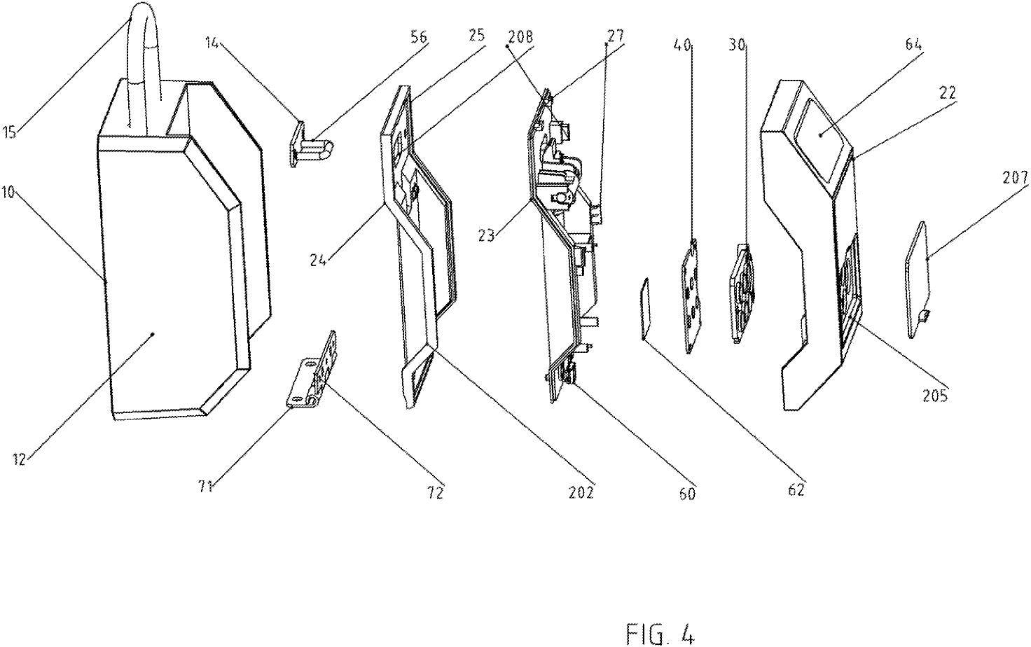

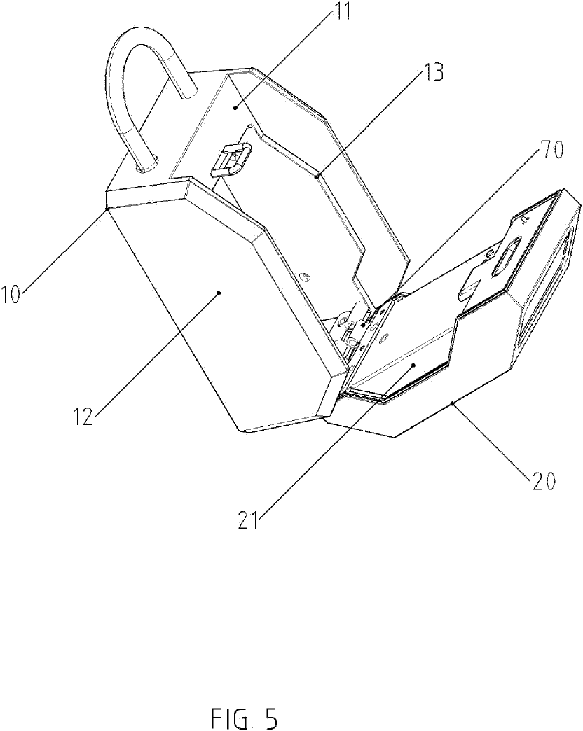

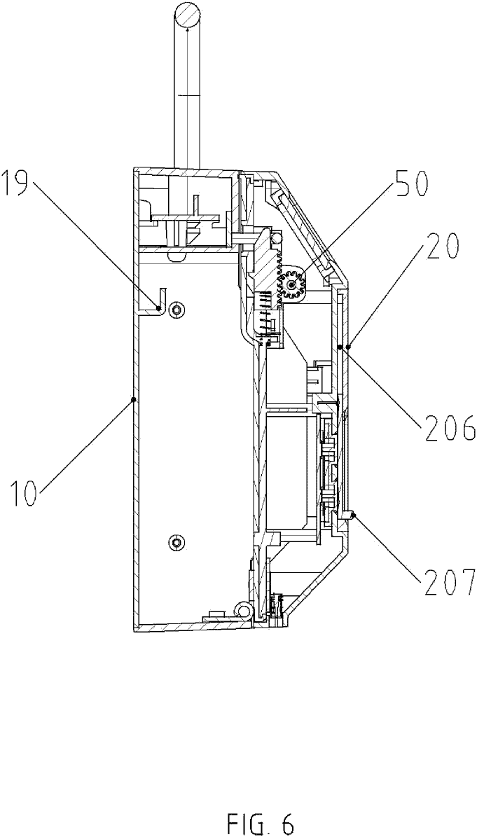

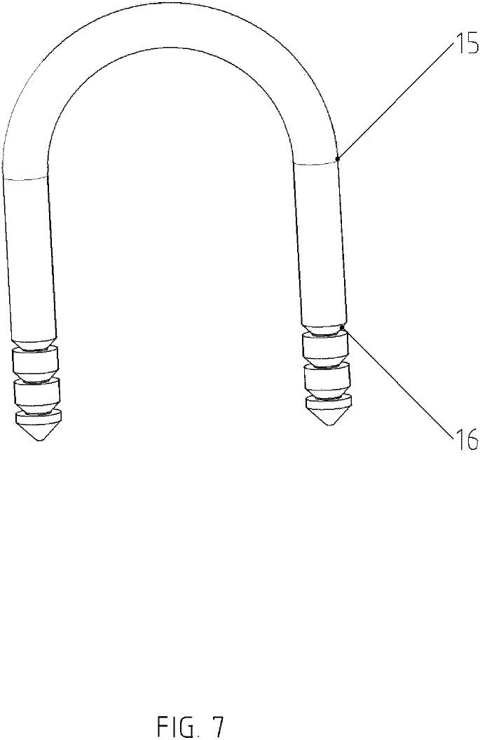

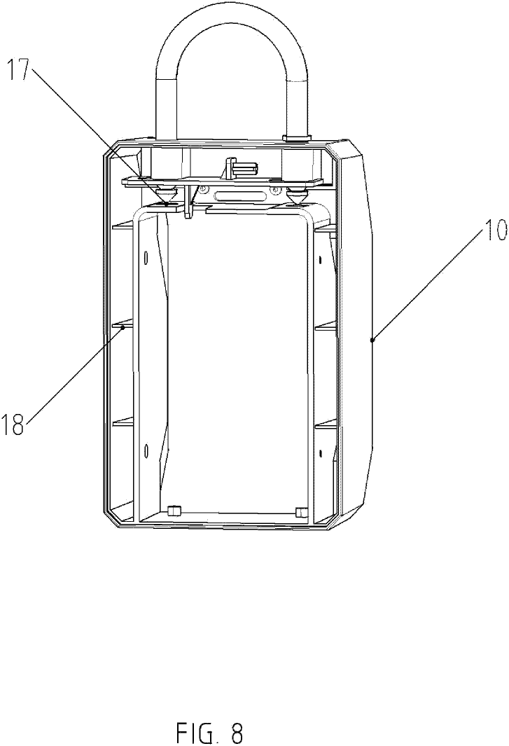

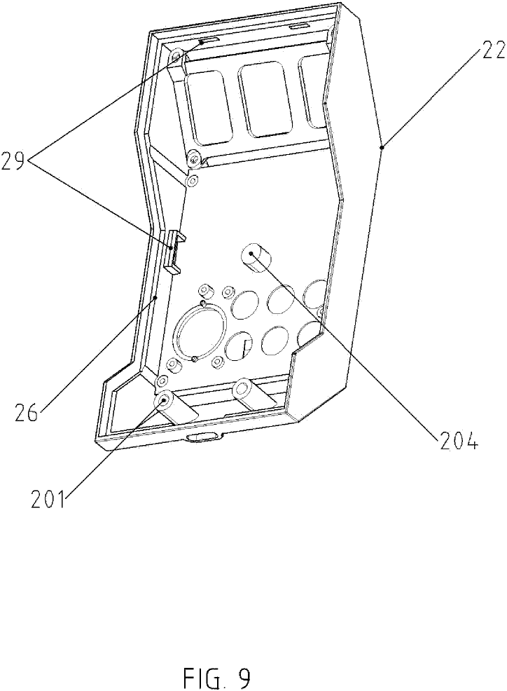

Please refer to FIG. 1 to FIG. 9, in one embodiment of the present disclosure, a key case, including a case body 10 for storing keys and a case cover 20 installed on the case body 10, the case cover 20 is a hollow shell structure, an unlocking drive unit 30, a main control unit 40, an unlocking execution unit 50 and a power supply unit 60 are arranged in the case cover 20, and the unlocking drive unit 30, the main control unit 40 and the unlocking execution unit 50 are electrically connected to the power supply unit 60 in respective;

The unlocking execution unit 50 includes a motor 51, a gear 52, a locking block 53 and a travel switch 54, the motor 51 is fixed in the case cover 20, and the gear 52 is in power fit with the motor 51; the locking block 53 is slidingly connected in the case cover 20, a rack 55 is arranged on the locking block 53, and the gear 52 meshes with the locking block 53 through the rack 55; the travel switch 54 is fixed in the case cover 20 and driven through the locking block 53; and a snap ring 56 is arranged on the case body 10, and the snap ring 56 is in clamping fit with the locking block 53.

A hinged structure 70 is arranged at a joint of the case body 10 and the case cover 20, and the case body 10 is rotationally connected to the case cover 20 through the hinged structure 70.

In the technical solution of the present disclosure, the case body 10 is a hollow structure with an opening, to store keys; the case cover 20 is a sealed hollow shell structure, which is used to install the unlocking drive unit 30, the main control unit 40, the unlocking execution unit 50 and the power supply unit 60; and the unlocking drive unit 30 is a password unlocking module which can provide unlocking function for the key case, the main control unit 40 is a circuit board with a timing function, and the main control unit 40 may be a singlechip. The time is controlled through a program, or a time relay, etc.; the unlocking execution unit 50 is a locking structure, which can provide the key case with a locking function; and the power supply unit 60 is a power supply module, which can provide power to the unlocking drive unit 30, the main control unit 40 and the unlocking execution unit 50.

The hinged structure 70 is shared at the lower end of the case body 10 and the lower end of the case cover 20, so that the case cover 20 may be rotationally connected to the case body 10 for closing and opening the case body 10, and then the key is convenient to take and place.

A first rotating shaft 57 is arranged in the case cover 20, the gear 52 rotates around the first rotating shaft 57, a first ratchet wheel 58 that is in power connection with an output end of the motor 51 is arranged on the motor 51, a second ratchet wheel 59 that fits with the first ratchet wheel 58 is formed on one end of the gear 52, and the first ratchet wheel 58 meshes with the second ratchet wheel 59 uniaxially.

A first fixed block 501 and a second fixed block 502 are arranged in the case cover 20, one end of the first rotating shaft 57 is fixed on the first fixed block 501, and the second fixed block 502 is arranged at one end of an activity journey of the locking block 53.

A first spring 503 is arranged on the first rotating shaft 57 and limited between the gear 52 and the first fixed block 501, a second rotating shaft 504 is arranged at the lower end of the locking block 53, a second spring 505 is arranged on the second rotating shaft 504, and the second spring 505 is limited between the locking block 53 and the second fixed block 502.

A lock bolt 506 is formed at the upper end of the locking block 53, the front end of the lock bolt 506 is a plane for clamping the snap ring 56, and the rear end of the lock bolt 506 is an inclined plane that is in guided fit with the snap ring 56.

In combination with the above technical solution, the unlocking and locking working principles of the key case are as follows:

After the user enters the correct password on the unlocking drive unit 30, the main control unit 40 sends a signal to drive the motor 51 to rotate clockwise, specifically the ratchet wheel 58 that is in power connection with the output end of the motor 51 rotates clockwise, so as to drive the second ratchet wheel 59, meshing with the first ratchet wheel 58 uniaxially, to rotate and clockwise, that is, drive the gear 52 integrally formed with the second ratchet wheel 59 to rotate clockwise, and the gear 52 rotates clockwise on the first rotating shaft 57; and after rotating clockwise, the gear 52 drives the locking block 53, meshing with the gear 52, to slide downwards.

The travel switch 54 and the second fixed block 502 may be all arranged below the locking block 53, and the snap ring 56 may be arranged on the case body 10, protrudes from one end and is in clamping fit with the locking block 53.

During the process of sliding downwards, the locking block 53 will touch the travel switch 54. The travel switch 54 sends a signal to the main control unit 40 after being touched, so that the main control unit 40 starts timing. During the timing period, the motor 51 applies the acting force which enables the locking block 53 to slide downwards, the locking block 53 continues to slide downwards so as to limit the counter-acting force applied to the locking block 53 by the second spring 505 on the locking block 53 and the second fixed block 502, thereby compelling the locking block 53 to slide upwards. A conflict generates between the acting force and the counter-acting force, at this time, a structure for combining the first ratchet wheel 58, the second ratchet wheel 59 and the first spring 503 will generate a clutch action to eliminate the counter-acting force. When the acting force applied to the locking block 53 by the motor 51 is less than the counter-acting force applied to the locking block 53 by the second spring 505, the locking block 53 slides upwards; when the acting force applied to the locking block 53 by the motor 51 is greater than the counter-acting force applied to the locking block 53 by the second spring 505, the locking block 53 slides downwards, and the locking block 53 slides back and forth slightly under the action of the acting force and the counter-acting force. The counter-acting force applied to the locking block 53 by the second spring 505 depends on the distance between the locking block 53 and the second fixed block 502. The greater the distance, the less the counter-acting force, and the closer the distance, the greater the counter-acting force.

It is to be noted that the upper end of the locking block 53 has been completely separated from the snap ring 56 when the travel switch 54 is triggered to time, that is, the unlocking is successful, and the locking block 53 slides back and forth slightly under the action of the acting force applied to the locking block 53 by the motor 51 and the counter-acting force applied to the locking block 53 by the second spring 505, and does not clamp with the snap ring 56 again. For example, the setting time is 5 s, which is the time for opening the case cover 20 after the user enters the password and unlocks successfully; and after 5 s is end, the motor 51 will stop rotating, the locking block 53 is only subjected to the counter-acting force of the second spring 505 to slide upwards, so as to return the original position.

When the user opens the case cover 20, takes out the key and recloses the case cover 20, the plane of the lock bolt 506 is clamped with the snap ring 56 again under the elastic action of the spring 505 since the rear end of the lock bolt 506 is an inclined surface fitting with the snap ring 56.

In conclusion, the motor 51 in the key case may complete the whole unlocking process through single rotation, the unlocking drive unit 30 can be prevented from supplying power always and maintaining the unlocking state, the power can be effectively saved, so that the key case is more energy-saving and environment-friendly.

In one embodiment of the present disclosure, teeth on the gear 52 and teeth on the rack 55 are all skewed tooth structures.

Through the above skewed tooth structures, the key case has strong transmission capacity, low noise and stable rotation, and the skewed gear 52 has short meshing time and a great contact area, so the stress is reduced.

In one embodiment of the present disclosure, the unlocking drive unit 30 includes electronic password unlocking 31 and fingerprint unlocking 32.

In order to improve the convenience of the key case, the key case includes the electronic password unlocking 31 and fingerprint unlocking 32 at the same time. The electronic password unlocking 31 is not easy to be cracked and opened due to better confidentiality and more coding quantities, and the fingerprint unlocking 32 is safe, reliable, convenient, quick, intelligent and fashion. The electronic password unlocking 31 and fingerprint unlocking 32 are arranged at the same time, so the key case has good stability and is convenient for different crowds.

In one embodiment of the present disclosure, the power supply unit 60 includes a battery pack 61, an emergency pouch battery 62, an emergency charging interface 63 and a solar liquid crystal board 64 that are arranged in the case body 10, and the emergency charging interface 63 and one end of the solar liquid crystal board 64 protrude from the case cover.

The key case is also provided with the solar liquid crystal board 64, the solar energy is converted into electric energy, so that the key case is more energy-saving. The replacing frequency of the battery is reduced, so the key case is more environment-friendly. The key case is also provided with the emergency pouch battery 62, when the battery pack 61 is in low power or the solar liquid crystal board 64 cannot be used due to external influence, the emergency pouch battery 62 may play a role of emergency power supply, and is very convenient. Furthermore, the key case is also provided with the emergency charging interface 63, which may be a Type-c interface. When considering the worst situation, that is, the battery pack 61, the solar liquid crystal board 64 and the emergency pouch battery 62 cannot supply power at the same time, the user can supply power to the key case with an external power supply, such as a portable power supply through the emergency charging interface 63 for unlocking. The key case is very complete in the power supply design and very humanized by designing the battery pack 61, the solar liquid crystal board 64, the emergency pouch battery 62 and the emergency charging interface 63.

The safety performance of the key case is also considered when the key case saves energy. Since the key case is an important article, which helps people store keys or room cards and the like, the safety coefficient of the key case must be ensured. However, the existing key case still has a certain defects on the safety coefficient, for example, the overall structure of the key case is not tight enough in design, the joint between the case body 10 and the case cover 20 is not rigorous, so the lawbreakers are easy to break the case cover 20 and take out the key, resulting in serious loss. Therefore, the following technical solution is proposed for the key case to improve the safety performance of the key case.

In one embodiment of the present disclosure, the opening of the case body 10 is arranged at the front end of the case body 10, a support frame 11 is arranged around the periphery of the case body 10, the periphery of the case cover 20 resists to the support frame 11, barrier plates 12, covering the two sides of the case cover 20, are respectively arranged on both sides of the case body 10, protrusion portions 13 that fit with the front end face of the case cover 20 are convexly arranged at the left and right positions, located on the support frame 11, of the case body 10 in respective, and depression portions 21 that fit with the protrusion portions 13 are concavely arranged on both sides of the case cover 20 in respective.

The key case adopts the double-sealing setting at left and right ends. First, the barrier plates 12, covering the two sides of the case cover 20, are formed on the two sides of the case body 10 in respective, this manner is used as the edge-sealing setting of the outer layers of the left and right ends of the key case, and the barrier plates 12 may be in a thickened design, so as to improve the strength. Second, the support frame 11 is arranged at the periphery of the opening of the case body 10, the periphery of the case cover 20 resists to the support frame 11, the protrusion portions 13 that fit with the front end face of the case cover 20 are convexly arranged at the left and right positions, located on the support frame 11, of the case body 10 in respective, the depression portions 21 that fit with the protrusion portions 13 are concavely arranged on the two sides of the case cover 20, and this manner is used as the edge-sealing setting of the inner layers of the left and right ends of the key case, so as to achieve the double-sealing effect. With high strength and high tightness, the key case enables the joint between the case cover 20 and the case body 10 to be sealed rigorously through the setting of double-sealing, the key case can prevent lawbreakers from damaging the case body 10 and case cover 20 through the gap between the case body 10 and the case cover 20 to take out the key in the case body 10.

In one embodiment of the present disclosure, the case cover 20 includes a front cover 22, a cover plate 23 and a rear cover 24, and the unlocking drive unit 30, the main control unit 40, the unlocking execution unit 50 and the power supply unit 60 are all arranged on the cover plate 23.

A fixed frame 25 is arranged at the periphery of the rear cover 24, the cover plate 23 is arranged on the rear cover 24 through the fixed frame 25, a step portion 26 is arranged on the periphery of the front cover 22, the front cover 22 is covered to the periphery of the rear cover 24 after resisting to the fixed frame 25 through the step portion 26, a male buckle 27 is arranged on the cover plate 23, a guide hole 28 is formed in the rear cover 24, and a female buckle 29 fitting with the male buckle 27 and a guide column 201 fitting with the guide hole 28 are arranged on the front cover 22.

The cover plate 23 in the key case may be arranged in the fixed frame 25 of the rear cover 24, the setting that the rear cover 24 wraps the cover plate 23 may further increase the strength of the cover plate 23 and the thickness of a bearing object, the male buckle 27 may be arranged at the upper, left and right ends of the cover plate 23, and the guide hole 28 is formed in the lower end of the rear cover 24. When the front cover 22 covers the cover plate 23 and the rear cover 24, the front cover 22 is in clamping fit with the female buckle 29 through the male buckle 27 at the upper, the left and right ends, the guide column 201 at the lower end is in guide fit with the guide hole 28, so that the interior of the case cover 20 may be fixed well, and at the same time, the step portion 26 of the front cover 22 resists to the fixed frame 25 of the rear cover 24, so the periphery of the case cover 20 may be fixed well, thereby improving the strength of the case cover 20 wholly.

In one embodiment of the present disclosure, the two ends of the fixed frame 25 are provided with support seats 202, and the depression portions 21 are arranged on the support seats 202.

The cover plate 23 is tightly adhered to one side of the support seat 202 or may be set as a structure similar to the support seat 202, so as to increase the support strength in the case body 10 and further increase the whole strength of the case body 10.

In one embodiment of the present disclosure, a reinforced bar 203 is also arranged on the cover plate 23, the two ends of the reinforced bar 203 resist to the two ends of the cover plate 23 in respective, and a resisting column 204 fitting with the reinforced bar 203 is arranged on the front cover 22.

The reinforced bar 203 may be arranged at a central position of the cover plate 23, specifically the left and right ends of the reinforced bar 203 resist to the left and right ends of the central position of the cover plate 23 in respective, and after the front cover 22 covers the cover plate 23, the resisting column 204 resists to the reinforced bar 203, so as to further improve the strength of the case cover 20.

In one embodiment of the present disclosure, a window 205 is arranged on the surface of the front cover 22, a drawer 206 corresponding to the window 205 is arranged in the front cover 22, the drawer 206 is slidingly connected to a sliding plate 207, which is used to open or close the window 205, and the control end of the unlocking drive unit 30 is arranged on the window 205.

During use, the window 205 may be opened by sliding the sliding plate 207; after entering the correct password at the control end of the unlocking drive unit 30, that is, the display panel of the electronic password unlocking 31 or fitting the correct fingerprint on the fingerprint end of the fingerprint unlocking 32, the upper end of the case cover 20 is separated from the upper end of the case body 10, so as to take out the key. When the key case is not used, the window 205 is closed through the sliding plate 207, which is very convenient, and at the same time, the unlocking drive unit 30 may be protected well, and the service life of the key case is prolonged.

In one embodiment of the present disclosure, a third fixed block 14 is fixedly installed at the upper end of the support frame 11, the snap ring 56 is fixedly installed on the third fixed block 14, through holes 208, corresponding to the snap ring 56, are formed on the rear cover 24 and the cover plate 23, where the through holes 208 correspond to the positions of the locking block 53, and one end the snap ring 56 penetrates through the through hole 208 and is in clamping fit with the locking block 53.

The third fixed block 14 may be fixedly installed at the back of the upper end of the support frame 11, that is, the third fixed block 14 is fixedly installed inside the case body 10, the snap ring 56 is U-shaped, one end of the snap ring 56 is arranged in a manner of protruding from the support frame 11, thereby further increasing the fitting strength between the snap ring 56 and the locking block 53.

In one embodiment of the present disclosure, the hinged structure 70 includes a fixed hinge 71 that is arranged at the lower end of the support frame 11 and a movable hinge 72 that is arranged at the lower end of the rear cover 24, and the fixed hinge 71 is in hinged fit with the movable hinge 72.

In one embodiment of the present disclosure, the case body 10 is detachably connected to a hook 15, a multi-layer clamping position 16 is arranged at the lower end of the hook 15, and a touch through hole 17 that fits with the multi-layer clamping position 16 is arranged in the case body 10.

The hook 15 may be set as a U-shaped structure, the key case may be locked at a door handle or other positions through the hook 15, which is very convenient. The multi-layer clamping position 16 is arranged at the lower end of the hook 15, the length of the hook 15 on the key case is adjusted according to an actual scenario, and the hook 15 is suitable for multiple scenarios, with better universality. When a shorter length of the hook 15 is required, the hook 15 moves downwards on the case body 10 by forming the touch through hole 17, that is, the length of the hook 15 in the case body 10 is increased correspondingly, at this time, the lower end of the hook 15 may pass through the touch through hole 17 and stretch to the storage space of the case body 10. It is to be noted that the activity journey of the hook 15 on the case body 10 may be defined according to the structure of the case body 10, that is, the level of the clamping position 16 is defined, so that the lower end of the hook 15 passes through the touch through hole 17 and stretches to the storage space of the case body 10 without affecting storage objects.

In one embodiment of the present disclosure, a plurality of bar positions 18, uniformly distributed, are arranged on the two ends of the case body 10.

The plurality of bar positions 18, uniformly distributed, may be arranged on left and right ends of the case body 10, and stretch front the front end to the rear end in the left and right ends of the case body 10, thereby greatly improving the strength of the case body 10.

In one embodiment of the present disclosure, an attachment 19 for hanging the keys is arranged in the case body 10.

The present disclosure is not apparently limited to the details of the above exemplary embodiments for those skilled in the art, and those skilled in the art may implement the present disclosure in other specific forms without departing from the spirit and basic features of the present disclosure. Therefore, in any case, the embodiment should be regarded as the exemplary embodiment, rather than the restrictive embodiment. The scope of the present disclosure is limited by the appended claims instead of the above description. Therefore, all changes in the meaning and scope of the equal conditions of the claims shall be included in the present disclosure.

What is claimed is:

1. A key case, comprising a case body for storing keys and a case cover installed on the case body, the case cover is a hollow shell structure, an unlocking drive unit, a main control unit, an unlocking execution unit and a power supply unit are arranged in the case cover, and the unlocking drive unit, the main control unit and the unlocking execution unit are electrically connected to the power supply unit in respective, wherein
the unlocking execution unit comprises a motor, a gear, a locking block and a travel switch, the motor is fixed in the case cover, and the gear is in power fit with the motor; the locking block is slidingly connected in the case cover, a rack is arranged on the locking block, and the gear meshes with the locking block through the rack; the travel switch is fixed in the case cover and driven through the locking block; and a snap ring is arranged on the case body, and the snap ring is in clamping fit with the locking block.

2. The key case according to claim 1, wherein a hinged structure is arranged at a joint of the case body and the case cover, and the case body is rotationally connected to the case cover through the hinged structure.

3. The key case according to claim 2, wherein a first rotating shaft is arranged in the case cover, the gear rotates around the first rotating shaft, a first ratchet wheel that is in power connection with an output end of the motor is arranged on the motor, a second ratchet wheel that fits with the first ratchet wheel is formed on one end of the gear, and the first ratchet wheel meshes with the second ratchet wheel uniaxially.

4. The key case according to claim 3, wherein a first fixed block and a second fixed block are arranged in the case cover, one end of the first rotating shaft is fixed on the first fixed block, and the second fixed block is arranged at one end of an activity journey of the locking block.

5. The key case according to claim 4, wherein a first spring is arranged on the first rotating shaft and limited between the gear and the first fixed block, a second rotating shaft is arranged at the lower end of the locking block, a second spring is arranged on the second rotating shaft, and the second spring is limited between the locking block and the second fixed block.

6. The key case according to claim 5, wherein a lock bolt is formed at the upper end of the locking block, the front end of the lock bolt is a plane for clamping the snap ring, and the rear end of the lock bolt is an inclined plane that is in guided fit with the snap ring.

7. The key case according to claim 1, wherein teeth on the gear and teeth on the rack are all skewed tooth structures.

8. The key case according to claim 1, wherein the unlocking drive unit comprises electronic password unlocking and fingerprint unlocking.

9. The key case according to claim 1, wherein the power supply unit comprises a battery pack, an emergency pouch battery, an emergency charging interface and a solar liquid crystal board that are arranged in the case body, and the emergency charging interface and one end of the solar liquid crystal board protrude from the case cover.

10. The key case according to claim 2, wherein the opening of the case body is arranged at the front end of the case body, a support frame is arranged around the periphery of the case body, the periphery of the case cover resists to the support frame, barrier plates, covering the two sides of the case cover, are respectively arranged on both sides of the case body, protrusion portions that fit with the front end face of the case cover are convexly arranged at the left and right positions, located on the support frame, of the case body in respective, and depression portions that fit with the protrusion portions are concavely arranged on both sides of the case cover in respective.

11. The key case according to claim 10, wherein the case cover comprises a front cover, a cover plate and a rear cover, and the unlocking drive unit, the main control unit, the unlocking execution unit and the power supply unit are all arranged on the cover plate.

12. The key case according to claim 11, wherein a fixed frame is arranged at the periphery of the rear cover, the cover plate is arranged on the rear cover through the fixed frame, a step portion is arranged on the periphery of the front cover, the front cover is covered to the periphery of the rear cover after resisting to the fixed frame through the step portion, a male buckle is arranged on the cover plate, a guide hole is formed in the rear cover, and a female buckle fitting with the male buckle and a guide column fitting with the guide hole are arranged on the front cover.

13. The key case according to claim 12, wherein the two ends of the fixed frame are provided with support seats, and the depression portions are arranged on the support seats.

14. The key case according to claim 12, wherein a reinforced bar is also arranged on the cover plate, the two ends of the reinforced bar resist to the two ends of the cover plate in respective, and a resisting column fitting with the reinforced bar is arranged on the front cover.

15. The key case according to claim 11, wherein a window is arranged on the surface of the front cover, a drawer corresponding to the window is arranged in the front cover, the drawer is slidingly connected to a sliding plate, which is used to open or close the window, and the control end of the unlocking drive unit is arranged on the window.

16. The key case according to claim 11, wherein a third fixed block is fixedly installed at the upper end of the support frame, the snap ring is fixedly installed on the third fixed block, through holes, corresponding to the snap ring, are formed on the rear cover and the cover plate, the through holes correspond to the position of the locking block, and one end the snap ring penetrates through the through hole and is in clamping fit with the locking block.

17. The key case according to claim 11, wherein the hinged structure comprises a fixed hinge that is arranged at the lower end of the support frame and a movable hinge that is arranged at the lower end of the rear cover, and the fixed hinge is in hinged fit with the movable hinge.

18. The key case according to claim 1, wherein the case body is detachably connected to a hook, a multi-layer clamping position is arranged at the lower end of the hook, and a touch through hole that fits with the multi-layer clamping position is arranged in the case body.

19. The key case according to claim 1, wherein a plurality of bar positions, uniformly distributed, are arranged on the two ends of the case body.

20. The key case according to claim 1, wherein an attachment for hanging the keys is arranged in the case body.
